(19) United States
(12) Patent Application Publication
(10) Pub. No.: US 2001/0050674 A1
(43) Pub. Date: Dec. 13, 2001

(54) Computer mouse device

(76) Inventor: Meng-Yu Wei, Taipei (TW)

Correspondence Address: DOUGHERTY & TROXELL, SUITE 1404, 5205 LEESBURG PIKE, FALLS CHURCH, VA, 22041, US

(21) Appl. No.: 09/915,300

(22) Filed: Jul. 27, 2001

Related U.S. Application Data
(63) Continuation-in-part of application No. 09/063,547, filed on Apr. 20, 1998, now Pat. No. 6,034,627.

(51) Int. Cl. G09G 5/08

(52) U.S. Cl. 345/163

(57) ABSTRACT

An improvement for computer mouse device includes a housing which has a bottom surface, a top surface, a first side surface, a second side surface, at least one button and a tracking device. A fillister shape is formed on the top surface and capable of accommodating at least one human figure, so that user's index finger may be rested on the fillister shape to move the mouse around for controlling curser motion and has the index finger tip drop vertically downward to press the button for selecting and excuting computer commands. The mouse is thus much more ergonomically designed and shaped to reduce muscle and nerve stress from undue jesture for fingers, palm and wrist. User may operate the mouse for a long period of time of reduced traditional stress and fatiuge or other harmful effect.

### BACKGROUND OF THE INVENTION

This is a continuation-in-part of Ser. No. 09/063,547, now U.S. Pat. No. 6,034,627 titled ‘A Computer Input Device’ granted to Applicant.

1. Field of the Invention

This invention relates to an improvement for computer mouse device and particularly to a mouse device that is small size and ergonomically shaped and designed to reduce finger stress for long time operation with minimum harmful effect on human muscle and nerve system.

2. Background of the Invention

Mouse device is a widely used computer input device nowadays. Conventional mouse devices are mostly shaped to fit into the palm of a user and be used by user singledhandly. A user usually has to put the palm over the top surface of the mouse, and uses a thumb and a ring finger to hold the lefthand side and righthand side of the mouse, and uses the index and middle finger to press a left and a right button for selecting and executing computer commands. Moving and using the mouse need coordinating motion of fingers, palm, wrist and forearm. Continuously using the mouse for a long time often causes stress on hand muscle and nerve, and may result in physical harmful effect and dropping of user's morale and productivity. There are small size mouse devices being developed that may be moved and used by the thumb and index finger with less movement of palm and wrist and forearm. However they are mostly not ergonomically designed and built, and not convenient to use. They generally have low market acceptance. Applicant tried to resolve this problem and had introduced an improved mouse device titled “A Computer Input Device” which was granted U.S. patent on Mar. 7, 2000 by U.S. Pat. No. 6,034,627. FIG. 1 shows a general structure of U.S. Pat. No. 6,034,627. The mouse device has a housing A which includes a bottom surface B, a top surface C, a first side surface D, a second side surface E, a left button F, a right button G and a tracking ball (not shown in the Figure). At the front end of the top surface, there is a through hole H formed in the housing A. The left button F is located in the through hole H. The right button G is located on the second side surface E. The hole H has a size capable to accommodate at least human's index finger. Furthermore, the bottom surface B has a front slope surface I and a back bottom surface J to form an angle at the juncture to easy mouse movement. The tracking ball is located on the bottom surface B. When in use, user's thumb holds the first side wall D, and the middle finger and ring finger hold the second side wall E to move the housing A left or right, while the index finger is put into the hole H to move the housing A forward or backward. Hence mouse motion may be made by finger and palm movement without moving the wrist or forearm. User's wrist and forearm may be placed on table top during mouse operation. Muscle and nerve stress on hand and wrist thus may be reduced. The size of mouse may be shrinked to about one half of a conventional mouse device.

However there are still some concerns when putting aforesaid invention to practice. For instance, it makes some people feel strange and uncomfortable when the index finger is confined in the hole H all the time. Incidentally pressing the left button F at the wrong time frequently happens. Furthermore, the index finger is almost being positioned horizontally like using a conventional mouse does. Horizontally positioned finger is awkward to give force when pressing the button and tends to produce stress easily. A better way should be letting finger tip hanging vertically downward to strike the button like playing piano or using typewriter so that muscle and nerve of human body and hand won't experience too much stress, especially when operating the mouse for a long period of time. All the prior arts for mouse device still have rooms for improvement in this respect.

### SUMMARY OF THE INVENTION

Therefore, it is a primary object of this invention to provide an improvement for mouse device that has a support member on the top surface of the housing for enabling user's index finger tip to hang downward and to make almost a vertical strike on the button. Hence a user may use the mouse more comfortably with less effort for a long periond of time without causing undue muscle stress or other harmful effect.

It is another object of the invention to provide an improvement for mouse device that has a support member with a concave and sinking curved opening for supporting user's index finger. It is ergonomically design that enables user to move and use the mouse more smoothly without causing false operation.

### BRIEF DESCRIPTION OF THE DRAWINGS

The foregoing features of the invention may be more fully understood from the following detailed description, read in conjunction with the accompanying drawings, wherein:

FIG. 1 is a perspective view of a conventional mouse device.

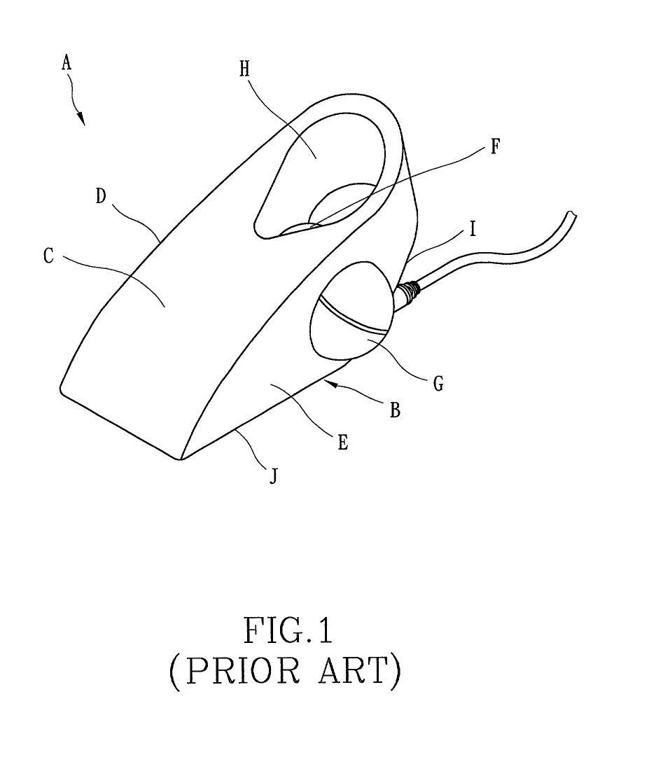

FIG. 2 is a perspective view of a preferred embodiment of the mouse in accordance with the present invention.

FIG. 3 is a side view of the mouse of the present invention in use.

FIG. 4 is a pictorial view of the present invention in use

FIG. 5 is a perspective view of another preferred embodiment of the mouse in accordance with the present invention.

FIG. 6 is a perspective view of another preferred embodiment of the mouse in accordance with the present invention.

### DETAILED DESCRIPTION OF THE PREFERRED EMBODIMENT

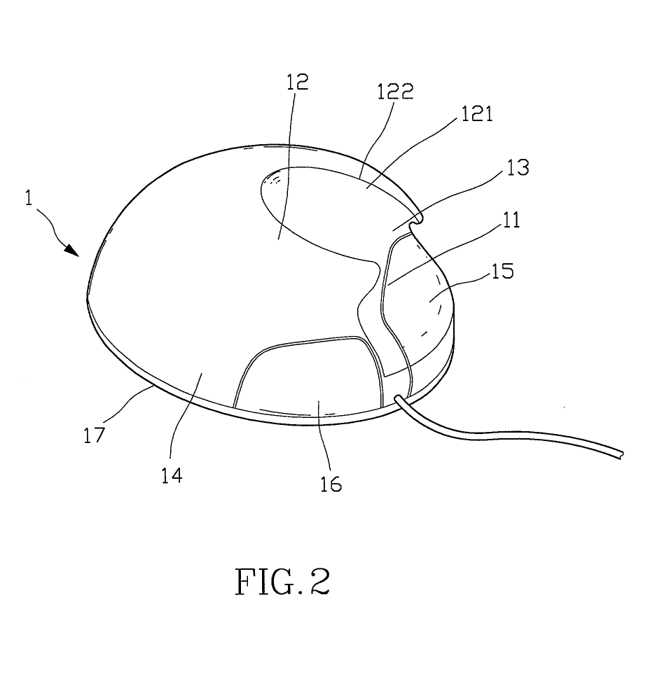

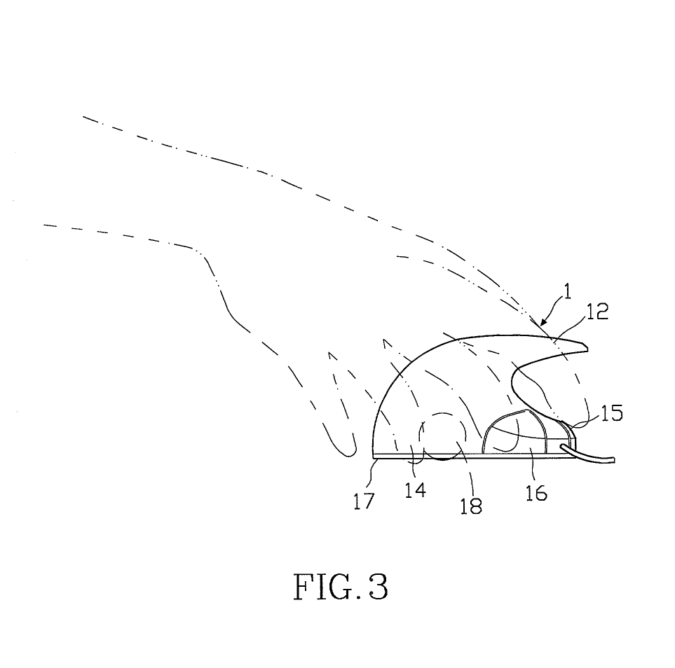

Referring to FIG. 2 and 3, the mouse according to the present invention includes a housing 1 which has a bottom surface 17, a top surface 11, a first side surface 13, a second side surface 14., a left button 15, a right button 16 and a tracking ball 18. The right button 16 is located on the top surface close to the second side surface 14. The tracking ball 18 is held within the housing 1 on the bottom surface 17 and is partially exposed outside the housing 1 through a bottom opening (shown in FIG. 3). On the top surface 11, there is a support member 12 mounted thereon. The support member 12 has a curve shaped flange 121 at one end with a front opening located on the upper part of mouse. The curve shaped flange is capable of accommodating at least one human fingure. The left button 15 is located below the opening of the flange 121.

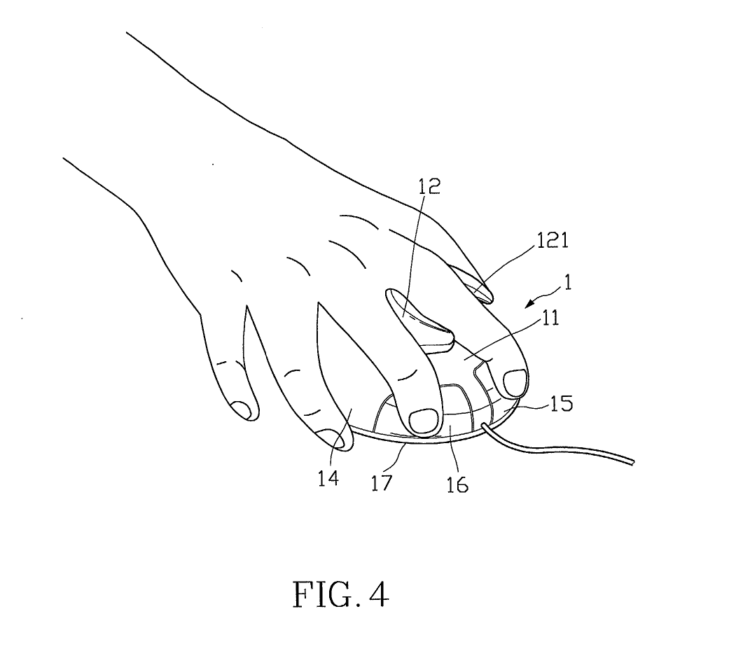

As shown in FIG. 3 and 4, when in use, a user may hold the housing 1 at the first and second side surface 13 and 14 by a thumb and a ring finger while the index finger resting on the support member 12 with the front tip of the index finger dropping downward vertically over the left button 15. The middle finger may vertically touch the right button 16. Then the mouse may be moved around easily by the thumb and ring finger, and the left and right buttons may be activated by the index and middle fingers easily. As pressing action on the buttons is done by finger tips at vertical position, the pressing force may be applied with less stress even under long time of operation, and won't cause much muscle stress and fatigue as conventional mouses do.

FIG. 2 also shows the support member has a smooth downward inclination angle 122 adjacent a rear edge of the curve shaped flange 121. It is also an ergonomical feature to enable the index finger to rest on the support member 12 even more comfortably and effortlessly. The front tip of the index finger may be dropped vertically downward naturally without causing much stress. The mouse may even be moved around by the index finger alone. This may further simplify the mouse operation.

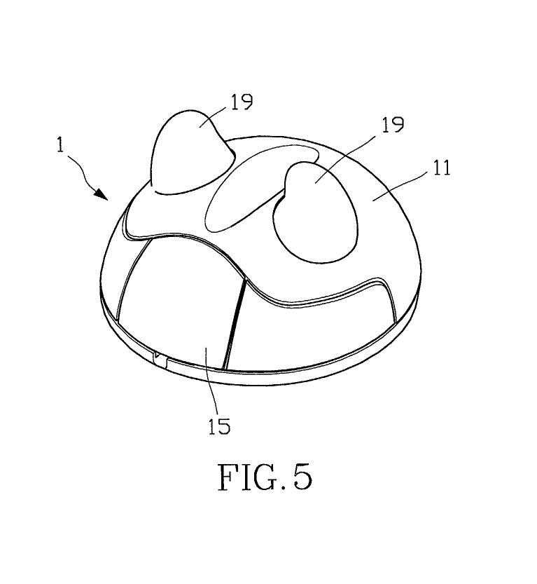

FIG. 5 shows another embodiment of this invention, wherein, buttons and housing are formed together by direct mold, and tracking device (not shown in figure) can be as a set of optical sensor. It is largely constructed like the one shown in FIG. 2. However instead of the support member 12 and crescent shaped flange 121, two spaced horn type bumps 19 are formed from left to right on the the top surface 11. The left button 15 is located in front of the space gap between the bumps 19. Then user's index finger may rest and nest between the bumps 19 to move the mouse around and activate the left button 15 easily and effortlessly.

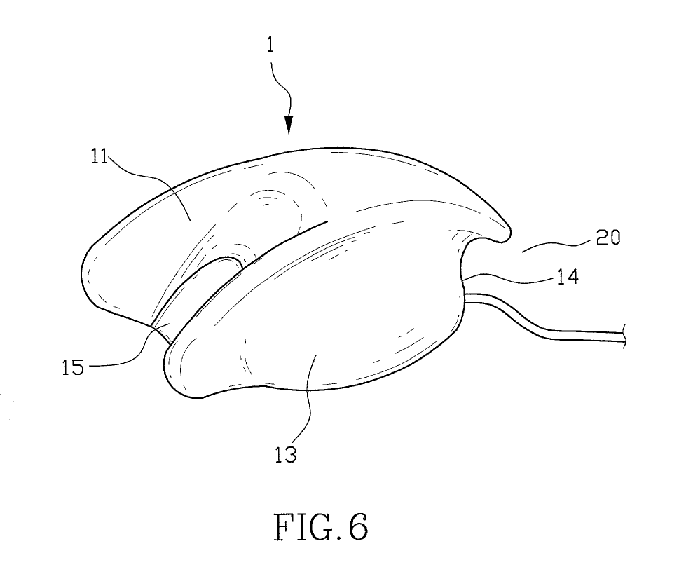

FIG. 6 shows another embodiment of this invention. The shape for the top surface 11 is totally different than the aforesaid embodiments, wherein, a housing 1 is with a bottom surface (not shown in figure), a top surface 11, a first side surface 13, a second side surface (not shown in figure), a button 15 and a tracking device (not shown in figure) located on the bottom surface; a fillister shape, flanked by flanges on both sides, is formed on the top surface 11 and at least one button, left button 15, is located on the top surface 11, wherein a rearmost part of the fillister shape, rear end 20, slightly protrudes the housing 1 for comforting wrist and palm when operating, and the rearmost part of the top surface protruding the housing 1 is a smooth downward inclination angle. The button 15 and the housing 1 are formed together by direct mold. Further, the fillister shape is distributed from left, the top of the first side surface 13, to right, the top of the second side surface 14, on the top surface 11, and from a front end, the front end of the button 15, to a rear end, the rear end 20, on the top surface 11 as well.

While the embodiments mentioned above use tracking ball 18 as an actuating means for controlling cursor movement, a set of optical sensor may also be used to replace the tracking ball for achieving same result. Although mouse of two buttons have been used as enbodiment examples, this invention may also be used for mouses of single button or more than two buttons (such as three, fourth or five buttons). The buttons may be located on the first side surface, second side surface or top surface as desired.

In summary, the mouse of the present invention is simply structured and may be made easily at low cost. Maintenance is also simple. It may be used and controlled easily by users through fingers. It won't cause much muscle or nerve stress on user's palm, wrist and arm as conventioanl mouses do, and may reduce fatigue and other harmful effect on users.

It may thus be seen that the objects of the present invention set forth herein, as well as those made apparent from the foregoing description, are efficiently attained. While the preferred embodiments of the invention have been set forth for purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

I claim:

1. An improvement for computer mouse device, comprising:
a housing having a bottom surface, a top surface, a first side surface, a second side surface, at least one button and a tracking device located on the bottom surface, and
a support member located on the top surface having a curve shaped flange which has a front opening located on the upper part of mouse; the curve shaped flange is capable of accommodating at least one human finger.

2. The improvement for computer mouse device of claim 1, wherein at least a side button is located on the top surface adjacent the second side surface.

3. The improvement for computer mouse device of claim 1, wherein in the support member further has a smooth downward inclination angle adjacent a rear edge of the curve shaped flange.

4. The improvement for computer mouse device of claim 1, wherein the tracking device is a set of optical sensor.

5. The improvement for computer mouse device of claim 1, wherein the button is more than one.

6. An improvement for computer mouse device, comprising:
a housing having a bottom surface, a top surface, a first side surface, a second side surface, at least one button and a tracking device located on the bottom surface, and
a pair of spaced protrude shaped bumps located on the top surface with a gap formed therebetween; the gap is capable of accommodating at least one human finger.

7. The improvement for computer mouse device of claim 6, wherein the button and the housing are formed together by direct mold.

8. The improvement for computer mouse device of claim 6, wherein the tracking device is a set of optical sensor.

9. The improvement for computer mouse device of claim 6, wherein the protrude shaped bumps are positioned from left to right on the top surface.

10. An improvement for computer mouse device, comprising:
a housing having a bottom surface, a top surface, a first side surface, a second side surface, at least one button and a tracking device located on the bottom surface, and
a fillister shape, flanked by flanges on both sides, is formed on the top surface, which being capable of accommodating at least one human fingure.

11. The improvement for computer mouse device of claim 10, wherein a rearmost part of the top surface protrudes the housing.

12. The improvement for computer mouse device of claim 11, wherein the rearmost part of the top surface protruding the housing is a smooth downward inclination angle.

13. The improvement for computer mouse device of claim 10, wherein the tracking ball is replaced by an optical sensor.

14. The improvement for computer mouse device of claim 10, wherein the fillister shape is distributed from left to right on the top surface.

15. The improvement for computer mouse device of claim 10, wherein the fillister is extended from a front end to a rear end on the top surface.

16. The improvement for computer mouse device of claim 10, wherein the button and the housing are formed together by direct mold.
